(19) United States
(12) Patent Application Publication
(10) Pub. No.: US 2025/0086769 A1
(43) Pub. Date: Mar. 13, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Woo Cheol Choi, Incheon (KR); Hyun Ju Kim, Yongin-Si (KR)

(21) Appl. No.: 18/614,994

(22) Filed: Mar. 25, 2024

(30) Foreign Application Priority Data
Sep. 13, 2023 (KR) 10-2023-0122061

(51) Int. Cl. G06T 7/00; B60W 60/00; G01S 7/497; G06T 7/13; G06T 7/73; G06T 17/00

(52) U.S. Cl. CPC G06T 7/0002; B60W 60/00; G06T 7/13; G06T 7/73; G06T 17/00; B60W 2420/408; G01S 2007/4975; G06T 2207/30252; G06T 2210/12

(57) ABSTRACT

The vehicle control apparatus may comprise a sensor and a processor configured to determine, based on frames obtained by using the sensor, a plane formed by a first axis and a second axis, the second axis corresponding to a driving direction of a vehicle, and the first axis being perpendicular to the second axis, detect objects in regions of interest of the plane, determine virtual boxes corresponding to the objects, generate a first field of view (FOV) based on the virtual boxes, determine ground points, generate a second FOV based on the ground points, generate a third FOV based on at least one of the first FOV, the second FOV, or angle information included in specification information of the sensor, determine a state of a boundary region of the sensor based on the third FOV, and output a signal indicating the determined state of the boundary region of the sensor.

### CROSS-REFERENCE TO RELATED APPLICATION

This application claims the benefit of priority to Korean Patent Application No. 10-2023-0122061, filed in the Korean Intellectual Property Office on Sep. 13, 2023, the entire contents of which are incorporated herein by reference.

### TECHNICAL FIELD

The present disclosure relates to a vehicle control apparatus and a method thereof, and more particularly, relates to a technology for identifying a state of a sensor (e.g., LiDAR).

### BACKGROUND

Various studies are being conducted to identify an external object by using various sensors to assist a host vehicle in driving.

In particular, while the host vehicle is driving in a driving assistance device activation mode or an autonomous driving mode, the external object may be identified by using a sensor (e.g., light detection and ranging (LiDAR)).

The field of view (FOV) of the LiDAR may be secured such that the LiDAR identifies the external object. For a user to remove a contamination on a surface of the sensor (e.g., LiDAR) to secure the FOV of the LiDAR, various methods of identifying the contamination on the surface of the LiDAR are considered.

### SUMMARY

According to the present disclosure, an apparatus for controlling a vehicle, the apparatus may comprise: a sensor; a processor; and a memory configured to store specification information of the sensor, wherein the processor is configured to: determine, based on a plurality of frames obtained by using the sensor, a plane formed by a first axis and a second axis, the second axis corresponding to a driving direction of the vehicle, and the first axis being perpendicular to the second axis; detect objects, external to the vehicle, in regions of interest of the plane; determine virtual boxes corresponding to the objects; generate a first field of view (FOV) based on the virtual boxes; determine ground points indicating a ground on the plane; generate a second FOV based on the ground points; generate a third FOV based on at least one of: the first FOV, the second FOV, or angle information included in the specification information; determine a state of a boundary region of the sensor based on the third FOV; and output a signal indicating the determined state of the boundary region of the sensor.

The apparatus, wherein the processor is configured to: specify a first region of interest (ROI) of the regions of interest, wherein the first ROI includes a region, which is between: a line rotated by a first angle from a half-line facing a positive direction of the second axis, and the half-line; and determine virtual boxes in the first ROI.

The apparatus, wherein the processor is configured to: determine a plurality of line segments, each of the plurality of line segments connecting the vehicle and one of a plurality of points included in the virtual boxes in the first ROI; determine a plurality of angles between: the plurality of line segments, and the half-line; determine a minimum angle among the plurality of angles, in each of the plurality of frames; and store, in the memory, at least one of: first minimum angles may comprise the minimum angle, or first minimum angle points, of the plurality of points, for forming each of the first minimum angles, wherein the first minimum angle points are determined in each of the plurality of frames.

The apparatus, wherein the processor is configured to: obtain at least one of: a first global minimum angle, which is the smallest of the first minimum angles, or a first global minimum angle point, of the first minimum angle points, for forming the first global minimum angle; and determine a reliability value of at least one of: the first global minimum angle, or the first global minimum angle point, based on determining whether at least one of: a number of the first minimum angles stored in the memory, or a number of the first minimum angle points stored in the memory satisfies a threshold number.

The apparatus, wherein the processor is configured to: specify a second ROI including a region, which is between: a line rotated by a second angle, greater than the first angle, from the half-line, and another line rotated by a third angle from the half-line; and determine virtual boxes in the second ROI.

The apparatus, wherein the processor is configured to: determine a plurality of line segments, each of plurality of line segments connecting the vehicle and one of a plurality of points included in the virtual boxes in the second ROI; determine a plurality of angles between: the plurality of line segments, and the half-line; determine a maximum angle among the plurality of angles, in each of the plurality of frames; and store, in the memory, at least one of: first maximum angles may comprise the maximum angle, or first maximum angle points, of the plurality of points, for forming each of the first maximum angles, wherein the first maximum angle points are determined in each of the plurality of frames.

The apparatus, wherein the processor is configured to: obtain at least one of: a first global maximum angle, which is the smallest of the first maximum angles, or a first global maximum angle point, of the first maximum angle points, for forming the first global maximum angle; and determine a reliability value of at least one of: the first global maximum angle, or the first global maximum angle point, based on determining whether at least one of: a number of the first maximum angles stored in the memory, or a number of the first maximum angle points stored in the memory satisfies a threshold number.

The apparatus, wherein the processor is configured to: determine a plurality of third line segments, each of the plurality of third line segments connecting the vehicle and one of the ground points; determine a plurality of angles between: the plurality of third line segments, and a half-line facing a positive direction of the second axis; identify a minimum angle among the plurality of angles, in each of the plurality of frames; and store, in the memory, at least one of: second minimum angles may comprise the minimum angle, or second minimum angle points, of the ground points, for forming each of the second minimum angles, wherein the second minimum angle points are determined in each of the plurality of frames.

The apparatus, wherein the processor is configured to: obtain at least one of: a second global minimum angle, which is the smallest of the second minimum angles, or a second global minimum angle point, of the second minimum angle points, for forming the second global minimum angle; and determine a reliability value of at least one of: the second global minimum angle, or the second global minimum angle point, based on determining whether at least one of: a number of the second minimum angles stored in the memory, or a number of the second minimum angle points stored in the memory satisfies a threshold number.

The apparatus, wherein the processor is configured to: determine a plurality of fourth line segments, each of the plurality of fourth line segments connecting the vehicle and one of the ground points; determine a plurality of angles between: the plurality of fourth line segments, and a half-line facing a positive direction of the second axis; identify a maximum angle among the plurality of angles, in each of the plurality of frames; and store, in the memory, at least one of: second maximum angles may comprise the maximum angle, or second maximum angle points, of the ground points, for forming each of the second maximum angles, wherein the second maximum angle points are determined in each of the plurality of frames.

The apparatus, wherein the processor is configured to: obtain at least one of: a second global maximum angle, which is the smallest of the second maximum angles, or a second global maximum angle point, of the second maximum angle points, for forming the second global maximum angle; and determine a reliability value of at least one of: the second global maximum angle, or the second global maximum angle point, based on determining whether at least one of: a number of the second maximum angles stored in the memory, or a number of the second maximum angle points stored in the memory satisfies a threshold number.

The apparatus, wherein the processor is configured to: determine a normal state of the boundary region of the sensor based on a difference between the third FOV and the angle information satisfying a threshold angle.

The apparatus, wherein the processor is configured to: determine an abnormal state of the boundary region of the sensor based on a difference between the third FOV and the angle information satisfying a threshold angle.

The apparatus, wherein the processor is configured to: after determining the abnormal state of the boundary region, determine an abnormal state of at least one of: the first ROI, or the second ROI, based on at least one of: the first FOV, the second FOV, the third FOV, or the angle information.

The apparatus, wherein the processor is configured to: before determining a contamination state of the sensor and including a contamination level of the sensor in the specification information, determine a state of the boundary region based on at least one of: the first FOV, the second FOV, the third FOV, or the angle information, wherein the contamination state is determined based on the contamination level satisfying a threshold value.

According to the present disclosure, a method for controlling a vehicle, the method may comprise: obtaining, by a sensor, a plurality of frames; determining, based on the plurality of frames, a plane formed by a first axis and a second axis, the second axis corresponding to a driving direction of the vehicle, and the first axis being perpendicular to the second axis; detecting objects, external to the vehicle, in regions of interest of the plane; determining virtual boxes corresponding to the objects; generating a first field of view (FOV) based on the virtual boxes; determining ground points indicating a ground on the plane; generating a second FOV based on the ground points; generating a third FOV based on at least one of: the first FOV, the second FOV, or angle information included in specification information of the sensor; determining a state of a boundary region of the sensor based on the third FOV; and outputting a signal indicating the determined state of the boundary region of the sensor.

The method, may further comprise: specifying a first region of interest (ROI) of the regions of interest, wherein the first ROI includes a region which is between: a line rotated by a first angle from a half-line facing a positive direction of the second axis, and the half-line; determining virtual boxes in the first ROI; specifying a second ROI including a region, which is between: a line rotated by a second angle, greater than the first angle, from the half-line, and another line rotated by a third angle from the half-line; determining virtual boxes in the second ROI; determining a plurality of first line segments, each of the plurality of first line segments connecting the vehicle and one of a plurality of first points included in the virtual boxes in the first ROI; determining a plurality of first angles between: the plurality of first line segments, and the half-line; determining a minimum angle among the plurality of first angles, in each of the plurality of frames; determining a plurality of second line segments, each of the plurality of second line segments connecting the vehicle and one of a plurality of second points included in the virtual boxes in the second ROI; determining a plurality of second angles between: the plurality of second line segments, and the half-line; determining a maximum angle among the plurality of second angles, in each of the plurality of frames; determining at least one of: first minimum angles determined in each of the plurality of frames, first minimum angle points, of the plurality of first points, for forming each of the first minimum angles, first maximum angles determined in each of the plurality of frames, or first maximum angle points, of the plurality of second points, for forming each of the first maximum angles; and generating the first FOV based on at least one of: a first global minimum angle, which is the smallest of the first minimum angles, a first global minimum angle point, of the first minimum angle points, for forming the first global minimum angle, a first global maximum angle, which is the greatest of the first maximum angles, or a first global maximum angle point, of the first maximum angle points, for forming the first global maximum angle.

The method, may further comprise: determining a plurality of third line segments, each of the plurality of third line segments connecting the vehicle and one of the ground points; determining a plurality of first angles between: the plurality of third line segments, and a half-line facing a positive direction of the second axis; determining a minimum angle among the plurality of first angles, in each of the plurality of frames; determining a plurality of fourth line segments, each of the plurality of fourth line segments connecting the vehicle and one of the ground points; determining a plurality of second angles between: the plurality of third line segments, and the half-line; determining a maximum angle among the plurality of second angles, in each of the plurality of frames; and generating the second FOV based on at least one of: a second global minimum angle, which is the smallest of second minimum angles, a second global minimum angle point, of second minimum angle points, for forming the second global minimum angle, a second global maximum angle, which is the greatest of second maximum angles, or a second global maximum angle point, of second maximum angle points, for forming the second global maximum angle among the second maximum angle points.

The method, may further comprise: determining a normal state of the boundary region of the sensor based on a difference between the third FOV and the angle information satisfying a threshold angle; or determining an abnormal state of the boundary region of the sensor based on the difference between the third FOV and the angle information not satisfying the threshold angle.

The method, may further comprise: storing, in a memory, at least one of: the first maximum angles, or the first maximum angle points for forming each of the first maximum angles, wherein the first maximum angles are determined in each of the plurality of frames.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus, according to an example of the present disclosure;

FIG. 2 shows an example of a vehicle control apparatus that identifies a minimum angle to generate a first FOV, in an example of the present disclosure;

FIG. 3 shows an example of a vehicle control apparatus that identifies a maximum angle to generate a first FOV, in an example of the present disclosure;

FIG. 4 shows an example of a vehicle control apparatus that identifies a minimum angle and a maximum angle to generate a second FOV, in an example of the present disclosure;

FIG. 5 shows an example in which a vehicle control apparatus determines an abnormal state of a boundary region, according to an example of the present disclosure;

FIG. 6 shows an example of a flowchart related to a vehicle control method, according to an example of the present disclosure;

FIG. 7 shows an example of a flowchart related to a vehicle control method, according to an example of the present disclosure;

FIG. 8 shows an example of a flowchart related to a vehicle control method, according to an example of the present disclosure;

FIG. 9 shows an example of a flowchart related to a vehicle control method, according to an example of the present disclosure; and

FIG. 10 shows an example of a computing system including a vehicle control apparatus, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

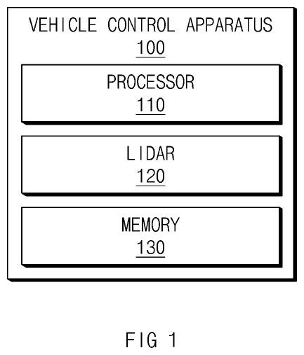

Hereinafter, various examples of the present disclosure will be described in detail with reference to FIGS. 1 to 10.

FIG. 1 shows an example of a block diagram of a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be connected to control units of the vehicle by means of a separate connection means. For example, the vehicle control apparatus 100 may further include components not shown in FIG. 1.

Referring to FIG. 1, the vehicle control apparatus 100 according to an example may include a processor 110, a LiDAR 120, and a memory 130. The processor 110, the LiDAR 120, or the memory 130 may be electrically or operably connected to each other by an electronic component including a communication bus.

Hereinafter, the fact that pieces of hardware are coupled operably may include the fact that a direct or indirect connection between the pieces of hardware is established wired or wirelessly such that second hardware is controlled by first hardware among the pieces of hardware. Although different blocks are shown, an example is not limited thereto. Some of the pieces of hardware in FIG. 1 may be included in a single integrated circuit including a system on a chip (SoC). The type or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or may have a structure of a multi-core processor including a dual core, a quad core, a hexa core, or an octa core.

The LiDAR 120 included in the vehicle control apparatus 100 according to an example may obtain data sets from identifying objects surrounding the vehicle control apparatus 100. For example, the LiDAR 120 may identify at least one of a location of the surrounding object, a movement direction of the surrounding object, a speed of the surrounding object, or any combination thereof based on a pulse laser signal that is emitted from the LiDAR 120, reflected by the surrounding object, and returned.

The memory 130 included in the vehicle control apparatus 100 according to an example may include a hardware component for storing data or instructions that are to be input or output to the processor 110 of the vehicle control apparatus 100.

For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), an embedded multi-media card (eMMC), or any combination thereof.

In an example, the memory 130 of the vehicle control apparatus 100 may store specification information of the LiDAR 120. For example, the memory 130 may receive the specification information from an external device different from the vehicle control apparatus 100 and may store the received specification information.

The processor 110 of the vehicle control apparatus 100 according to an example may obtain a plurality of frames by using the LiDAR 120. For example, a plurality of frames obtained by using the LiDAR 120 may include frames based on a three-dimensional virtual coordinate system including an x-axis, a y-axis, and a z-axis. In the description below, a first axis may include the x-axis. A second axis may include the y-axis. A third axis may include the z-axis. The x-axis, the y-axis, and the z-axis may be perpendicular to each other. Hereinafter, for convenience of description, the first axis is referred to as the “x-axis”; the second axis is referred to as the “y-axis”; and the third axis is referred to as the “z-axis”. However, an example of the present disclosure is not limited to the above description.

The processor 110 may identify virtual boxes corresponding to external objects, in a plurality of frames obtained by using the LiDAR 120. For example, in the plurality of frames obtained by using the LiDAR 120, the processor 110 may identify virtual boxes corresponding to external objects identified in regions of interest (ROIs) of a plane formed by the x-axis and y-axis among the x-axis, the y-axis, and the z-axis, and may generate a first FOV based on the virtual boxes.

For example, the processor 110 may specify a first ROI including a region, which is rotated clockwise by a first angle based on a half-line facing a positive direction of the y-axis from the host vehicle, from among the ROIs. The processor 110 may identify the virtual boxes in the first ROI. For example, the first ROI may be referred to as a “low limit area”.

According to an example, the processor 110 may specify the first ROI based on at least one of angle information included in the specification information, the region, which is rotated clockwise by the first angle based on the half-line facing the positive direction of the y-axis from the host vehicle, from among the ROIs, or any combination thereof. For example, the angle information may be referred to as scalar gen2 FOV angle. For example, the angle information may include an angle of approximately 133 degrees.

For example, the processor 110 may specify a second ROI including a region, which is rotated clockwise by a second angle greater than the first angle based on the half-line facing the positive direction of the y-axis from the host vehicle, from among the ROIs. The processor 110 may identify the virtual boxes in the second ROI. For example, the second ROI may be referred to as a “high limit area”.

According to an example, the processor 110 may specify the second ROI based on at least one of the angle information included in the specification information, the region, which is rotated clockwise by the second angle greater than the first angle based on the half-line facing the positive direction of the y-axis from the host vehicle, from among the ROIs, or any combination thereof.

In an example, the processor 110 may identify ground points indicating the ground on a plane formed by the x-axis and the y-axis among the x-axis, the y-axis, and the z-axis. The processor 110 may identify the ground points indicating the ground on the plane formed by the x-axis and the y-axis among the x-axis, the y-axis, and the z-axis, and may generate the second FOV based on the ground points.

In an example, the processor 110 may identify a third FOV based on at least one of the first FOV based on the virtual boxes, the second FOV based on the ground points, the angle information included in the specification information, or any combination thereof. For example, the third FOV may include an FOV that is the closer to the angle information among the first FOV and the second FOV.

For example, if the angle information includes 133 degrees, the processor 110 may set the second FOV among the first FOV and the second FOV as the third FOV based on the first FOV being identified as 121 degrees and the second FOV being identified as 130 degrees.

The processor 110 may identify the third FOV based on at least one of the first FOV based on the virtual boxes, the second FOV based on the ground points, the angle information included in the specification information, or any combination thereof, and may determine the state of the boundary region of the LiDAR 120. For example, the processor 110 may determine the state of the boundary region of the LiDAR 120 by comparing the third FOV with the angle information included in the specification information.

In an example, the processor 110 may determine a normal state of the boundary region of the LiDAR 120 based on the fact that a difference between the third FOV and the angle information included in the specification information is smaller than a specified angle.

In an example, the processor 110 may determine an abnormal state of the boundary region of the LiDAR 120 based on the fact that the difference between the third FOV and the angle information included in the specification information is not greater than the specified angle.

In an example, after determining the abnormal state of the boundary region, the processor 110 may determine the abnormal state of at least one of the first ROI, the second ROI, or any combination thereof based on at least one of the first FOV, the second FOV, the third FOV, the angle information, or any combination thereof.

Hereinafter, an example of the vehicle control apparatus 100 that generates the first FOV will be described.

In an example, the processor 110 may identify the first ROI including a region, which is rotated clockwise by a first angle based on a half-line facing a positive direction of the y-axis from the host vehicle, from among the ROIs. The processor 110 may identify virtual boxes corresponding to external objects in the first ROI.

For example, the processor 110 may identify the virtual boxes in a current frame. The processor 110 may identify a plurality of points included in virtual boxes identified in the current frame. The processor 110 may identify an angle between the half-line facing in the positive direction of a y-axis from the host vehicle and a first line segment from connecting a plurality of points, among the plurality of points included in the virtual boxes.

In an example, in each of the plurality of frames, the processor 110 may identify first line segments from connecting the host vehicle with each of the plurality of points included in the virtual boxes identified in the first ROI. The processor 110 may identify an angle between the first line segments and the half-line facing the positive direction of the y-axis from the host vehicle. The processor 110 may identify a minimum angle among angles between the first line segments and the half-line facing the positive direction of the y-axis from the host vehicle.

The processor 110 may identify at least one of first minimum angles, first minimum angle points for forming the first minimum angles among the plurality of points, or any combination thereof, which is identified in each of the plurality of frames. The processor 110 may store at least one of the first minimum angles, the first minimum angle points for forming the first minimum angles among the plurality of points, or any combination thereof in the memory 130, which is identified in each of the plurality of frames.

In an example, the processor 110 may obtain at least one of a first global minimum angle, which is the smallest of the first minimum angles, a first global minimum angle point for forming the first global minimum angle among the first minimum angle points, or any combination thereof. The processor 110 may determine whether at least one of the first minimum angles, the first minimum angle points, or any combination thereof is stored in the memory 130 as many as the specified number of more. For example, the global minimum angle may include the smallest angle among angles identified by points, in the plurality of frames. For example, the global maximum angle may include the greatest angle among angles identified by points, in the plurality of frames.

The processor 110 may determine the reliability of at least one of the first global minimum angle, the first global minimum angle point, or any combination thereof based on determining whether at least one of the first minimum angles, the first minimum angle points, or any combination thereof is stored in the memory as many as the specified number or more. For example, the specified number may include approximately 50.

For example, on the basis of identifying at least one of first minimum angles stored as many as the specified number or more, first minimum angle points stored as many as the specified number or more, or any combination thereof, the processor may identify the reliability indicating the availability of at least one of the first global minimum angle, the first global minimum angle point, or any combination thereof, which is based on at least one of the first minimum angles, the first minimum angle points, or any combination thereof.

For example, the processor 110 may identify at least one of the first global minimum angle, the first global minimum angle point, or any combination thereof based on identifying that at least one of the first minimum angles, the first minimum angle points, or any combination thereof is stored as many as the specified number or more.

For example, if at least one of the first minimum angles, the first minimum angle points, or any combination thereof is identified such that the number of first minimum angles, first minimum angle points, or any combination thereof is smaller than the specified number, the processor 110 may additionally or alternatively perform a process of obtaining the first minimum angles and the first minimum angle points.

In an example, in each of the plurality of frames, the processor 110 may identify second line segments from connecting the host vehicle to each of the plurality of points included in the virtual boxes identified in the first ROI. The processor 110 may identify an angle between the second line segments and the half-line facing the positive direction of the y-axis from the host vehicle. The processor 110 may identify a maximum angle among angles between the second line segments and the half-line facing the positive direction of the y-axis from the host vehicle.

The processor 110 may identify at least one of first maximum angles, first maximum angle points for forming the first maximum angles among the plurality of points, or any combination thereof, which is identified in each of the plurality of frames. The processor 110 may store at least one of the first maximum angles, the first maximum angle points for forming the first maximum angles among the plurality of points, or any combination thereof, which is identified in each of the plurality of frames, in the memory 130.

In an example, the processor 110 may obtain at least one of a first global maximum angle, which is the greatest of the first maximum angles, a first global maximum angle point for forming the first global maximum angle among the first maximum angle points, or any combination thereof. The processor 110 may determine whether at least one of the first maximum angles, the first maximum angle points, or any combination thereof is stored in the memory 130 as many as a specified number or more.

The processor 110 may determine the reliability of at least one of the first global maximum angle, the first global maximum angle point, or any combination thereof based on determining whether at least one of the first maximum angles, the first maximum angle points, or any combination thereof is stored in the memory as many as the specified number or more. For example, the specified number may include approximately 50.

For example, on the basis of identifying at least one of first maximum angles stored as many as the specified number or more, first maximum angle points stored as many as the specified number or more, or any combination thereof, the processor may identify the reliability indicating the availability of at least one of the first global maximum angle, the first global maximum angle point, or any combination thereof, which is based on at least one of the first maximum angles, first maximum angle points, or any combination thereof.

For example, the processor 110 may identify at least one of the first global maximum angle, the first global maximum angle point, or any combination thereof based on identifying that at least one of the first maximum angles, the first maximum angle points, or any combination thereof is stored as many as the specified number or more.

For example, if at least one of the first maximum angles, the first maximum angle points, or any combination thereof is identified such that the number of first maximum angles, first maximum angle points, or any combination thereof is smaller than the specified number, the processor 110 may additionally or alternatively perform a process of obtaining the first maximum angles and the first maximum angle points.

In an example, the processor 110 may generate the first FOV based on at least one of the first global minimum angle, the first global minimum angle point, the first global maximum angle, the first global maximum angle point, or any combination thereof.

For example, the processor 110 may generate the second FOV based on a region between a line segment from connecting the host vehicle and the second global minimum angle point, and a line segment from connecting the host vehicle and the second global maximum angle point. For example, the processor 110 may generate the first FOV including the first global minimum angle point and the first global maximum angle point.

Hereinafter, an example of the vehicle control apparatus 100 that generates the second FOV will be described.

In an example, in each of the plurality of frames, the processor 110 may identify the minimum angle among angles between the half-line facing the positive direction of the y-axis from the host vehicle and a third line segments from connecting each of the host vehicle and ground points.

The processor 110 may identify at least one of second minimum angles, second minimum angle points for forming the second minimum angles among ground points, or any combination thereof, which is identified in each of the plurality of frames. The processor 110 may store, in the memory 130, at least one of the second minimum angles, the second minimum angle points for forming the second minimum angles among the ground points, or any combination thereof, which is identified in each of the plurality of frames.

In an example, the processor 110 may obtain at least one of a second global minimum angle, which is the smallest of the second minimum angles, a second global minimum angle point for forming the second global minimum angle among the second minimum angle points, or any combination thereof.

The processor 110 may determine the reliability of at least one of the second global minimum angle, the second global minimum angle point, or any combination thereof based on determining whether at least one of the second minimum angles, the second minimum angle points, or any combination thereof is stored in the memory 130 as many as the specified number or more.

For example, on the basis of identifying at least one of second minimum angles stored as many as the specified number or more, second minimum angle points stored as many as the specified number or more, or any combination thereof, the processor may identify the reliability indicating the availability of at least one of the second global minimum angle, the second global minimum angle point, or any combination thereof, which is based on at least one of the second minimum angles, the second minimum angle points, or any combination thereof.

For example, the processor 110 may identify at least one of the second global minimum angle, the second global minimum angle point, or any combination thereof based on identifying that at least one of the second minimum angles, the second minimum angle points, or any combination thereof is stored as many as the specified number or more.

For example, if at least one of the second minimum angles, the second minimum angle points, or any combination thereof is identified such that the number of second minimum angles, second minimum angle points, or any combination thereof is smaller than the specified number, the processor 110 may additionally or alternatively perform a process of obtaining at least one of second minimum angles, second minimum angle points, or any combination thereof.

In an example, in each of the plurality of frames, the processor 110 may identify the maximum angle among angles between the half-line facing the positive direction of the y-axis from the host vehicle and a fourth line segments from connecting each of the host vehicle and ground points.

The processor 110 may identify at least one of second maximum angles, second maximum angle points for forming the first maximum angles among the ground points, or any combination thereof, which is identified in each of the plurality of frames. The processor 110 may store at least one of the second maximum angles, the second maximum angle points for forming the second maximum angles among the ground points, or any combination thereof, which is identified in each of the plurality of frames, in the memory 130.

In an example, the processor 110 may obtain at least one of a second global maximum angle, which is the greatest of the second maximum angles, a second global maximum angle point for forming the second global maximum angle among the second maximum angle points, or any combination thereof.

The processor 110 may determine the reliability of at least one of the second global maximum angle, the second global maximum angle point, or any combination thereof based on determining whether at least one of the second maximum angles, the second maximum angle points, or any combination thereof is stored in the memory 130 as many as the specified number or more.

For example, on the basis of identifying at least one of second maximum angles stored as many as the specified number or more, second maximum angle points stored as many as the specified number or more, or any combination thereof, the processor may identify the reliability indicating the availability of at least one of the second global maximum angle, the second global maximum angle point, or any combination thereof, which is based on at least one of the second maximum angles, second maximum angle points, or any combination thereof.

For example, the processor 110 may identify at least one of the second global maximum angle, the second global maximum angle point, or any combination thereof based on identifying that at least one of the second maximum angles, the second maximum angle points, or any combination thereof is stored as many as the specified number or more.

For example, if at least one of the second minimum angles, the second minimum angle points, or any combination thereof is identified such that the number of second minimum angles, second minimum angle points, or any combination thereof is smaller than the specified number, the processor 110 may additionally or alternatively perform a process of obtaining at least one of second minimum angles, second minimum angle points, or any combination thereof.

In an example, the processor 110 may generate the second FOV based on at least one of the second global minimum angle, the second global minimum angle point, the second global maximum angle, the second global maximum angle point, or any combination thereof.

According to an example, on the basis of identifying at least one of the second minimum angles, the second minimum angle points, the second maximum angles, the second maximum angle points, or any combination thereof based on the ground points, the processor 110 may store at least one of the identified second minimum angles, second minimum angle points, second maximum angles, second maximum angle points, or any combination thereof in the memory 130.

If at least one of second minimum angles, second minimum angle points, second maximum angles, second maximum angle points, or any combination thereof is stored in the memory 130 as many as the specified number or more, the processor 110 may obtain at least one of a second global minimum angle, a second global minimum angle point, a second global maximum angle, a second global maximum angle point, or any combination thereof.

In an example, the processor 110 may generate the second FOV based on at least one of the second global minimum angle, the second global minimum angle point, the second global maximum angle, the second global maximum angle point, or any combination thereof.

For example, the processor 110 may generate the second FOV based on a region between a line segment from connecting the host vehicle and the second global minimum angle point, and a line segment from connecting the host vehicle and the second global maximum angle point. For example, the processor 110 may generate the second FOV including the second global minimum angle point and the second global maximum angle point.

Hereinafter, an example of the vehicle control apparatus 100 that identifies a third FOV will be described.

In an example, the processor 110 may generate a first FOV and a second FOV. The processor 110 may identify the first FOV, the second FOV, and a third FOV based on angle information included in specification information. For example, the third FOV may include a FOV that is the closer to the angle information included in the specification information among the first FOV and the second FOV.

The processor 110 may determine a state of a boundary region of the LiDAR 120 by identifying the third FOV. For example, the boundary region of the LiDAR 120 may include a boundary line of a region, which is different from the entire region, in the entire region in which the LiDAR 120 detects an external object.

In an example, the processor 110 may determine a normal state of the boundary region of the LiDAR 120 based on the fact that a difference between the third FOV and the angle information included in the specification information is smaller than a specified angle. For example, the specified angle may include approximately 3 degrees.

In an example, the processor 110 may determine an abnormal state of the boundary region of the LiDAR 120 based on the fact that the difference between the third FOV and the angle information included in the specification information is not greater than the specified angle.

In an example, after determining the abnormal state of the boundary region of the LiDAR 120, the processor 110 may determine the abnormal state of at least one of the first ROI, the second ROI, or any combination thereof based on at least one of the first FOV, the second FOV, the third FOV, the angle information, or any combination thereof.

For example, the processor 110 may identify an abnormal state of at least one of the first ROI, the second ROI, or any combination thereof, based on the third FOV and the angle information. For example, the processor 110 may identify the abnormal state of at least one of the first ROI, the second ROI, or any combination thereof based on at least one of the first global minimum angle point, the first global maximum angle point, or any combination thereof, which is used to identify the third FOV.

For example, the processor 110 may identify an abnormal state of at least one of the first ROI, the second ROI, or any combination thereof based on the fact that at least one of the first global minimum angle point, the first global maximum angle point, or any combination thereof is out of a specified distance from a point included in the angle information.

For example, the processor 110 may include an operation of determining the abnormal state of the first ROI based on the fact that a global minimum angle included in the third FOV is greater than a minimum angle included in the angle information. For example, the global minimum angle included in the third FOV may include at least one of the first global minimum angle for generating the first FOV, the first global minimum angle point, or any combination thereof. For example, the global minimum angle included in the third FOV may include at least one of the second global minimum angle for generating the second FOV, the second global minimum angle point, or any combination thereof.

For example, the processor 110 may include an operation of determining the abnormal state of the second ROI based on the fact that the global maximum angle included in the third FOV is smaller than the maximum angle included in the angle information. For example, the global maximum angle included in the third FOV may include at least one of the first global maximum angle for generating the first FOV, the first global maximum angle point, or any combination thereof. For example, the global maximum angle included in the third FOV may include at least one of the second global maximum angle for generating the second FOV, the second global maximum angle point, or any combination thereof.

In an example, the processor 110 may identify a contamination level of the LiDAR 120. For example, the processor 110 may identify the contamination level of the LiDAR 120 based on specification information. Before the contamination level of the LiDAR 120 is included in the specification information and identified as a threshold value for determining the contamination state of the LiDAR 120, the processor 110 may determine the state of the boundary region based on the first FOV, the second FOV, the third FOV, angle information included in the specification information, or any combination thereof.

In an example, the processor 110 may provide a user with a guide based on the fact that it is determined that a state of a boundary region is an abnormal state. For example, the processor 110 may provide a notification that the state of the boundary region of the LiDAR 120 is determined to be an abnormal state, by using at least one of a display device including a display, an output device including a speaker, or any combination thereof in a vehicle control system including the vehicle control apparatus 100.

As mentioned above, the processor 110 of the vehicle control apparatus 100 according to an example may determine the state of the boundary region of the LiDAR 120 based on at least one of the first FOV, the second FOV, the third FOV, the angle information included in the specification information, or any combination thereof. The processor 110 may identify that the state of the boundary region of the LiDAR 120 is an abnormal state, and may guide the user such that he/she may take action, thereby preventing performance degradation of the LiDAR 120.

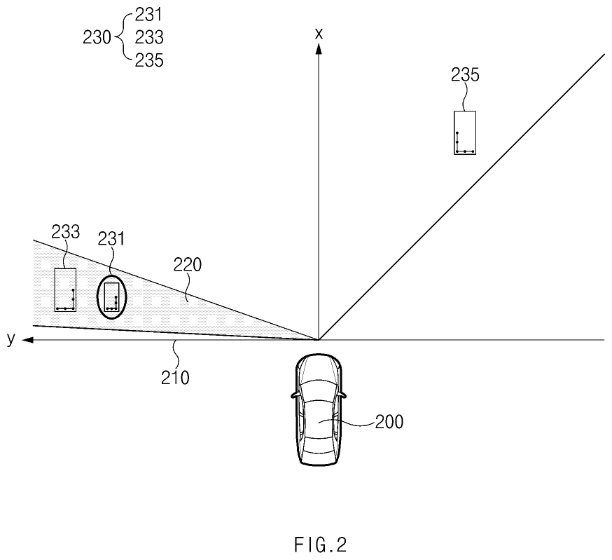

FIG. 2 shows an example of a vehicle control apparatus that identifies a minimum angle to generate a first FOV, in an example of the present disclosure.

A host vehicle 200 of FIG. 2 may include the vehicle control apparatus 100 of FIG. 1.

Referring to FIG. 2, a processor of a vehicle control apparatus according to an example may identify a virtual box 230 corresponding to an external object different from the host vehicle 200. For example, the external object may include at least one of an external vehicle, a guardrail, a pedestrian, a stationary object, or any combination thereof.

For example, the virtual boxes 230 may refer to a meta object. For example, the meta object may include an object having the same data format as a track channel for tracking the external object.

For example, the processor may identify a half-line 210 facing a positive direction of the y-axis from the host vehicle 200. The processor may specify a first ROI 220 that includes a region rotated clockwise by a first angle from the half-line 210. For example, the first ROI 220 may include a region rotated about 20 degrees clockwise from the half-line 210.

In an example, the processor may use specification information of a LiDAR when specifying the first ROI 220. For example, the processor may specify the first ROI 220 by using angle information included in the specification information of the LiDAR.

The processor may identify virtual boxes 231 and 233 in the first ROI 220. The processor may identify a plurality of points included in the virtual boxes 231 and 233 identified in the first ROI 220.

In an example, the processor may obtain first line segments from connecting the host vehicle 200 and each of the plurality of points included in the virtual boxes 231 and 233.

The processor may identify angles between the first line segments and the half-line 210. The processor may identify the minimum angle among the angles between the first line segments and the half-line 210.

In an example, the processor may identify the minimum angle based on identifying a virtual box that satisfies a specified condition. For example, the processor may identify the minimum angle by using the virtual box 231 based on identifying the virtual box 231, in which an external object is spaced by a specified distance or more in a lateral direction (e.g., a y-axis direction) of the host vehicle 200 and is not obscured by another external object, in the first ROI 220.

In an example, in each of a plurality of frames, the processor may obtain first line segments from connecting the host vehicle 200 and each of the plurality of points included in the virtual boxes 231 and 233. The processor may identify angles between the first line segments and the half-line 210 in each of the plurality of frames. In each of the plurality of frames, the processor may identify the first minimum angles based on identifying the minimum angle among the angles between the first line segments and the half-line 210.

In an example, the processor may store the identified first minimum angles in a memory. The processor may sequentially store the first minimum angles in the memory.

In an example, the processor may store at least one of first minimum angles, first minimum angle points, or any combination thereof in the memory, and the processor may also store at least one of a direction that the LiDAR faces, an index, or any combination thereof.

For example, the direction that the LiDAR faces may include an identifier corresponding to the left or an identifier corresponding to the right. For example, the index may include a frame, in which the first minimum angles are identified, and locations of the first minimum angles stored in the memory.

In an example, the processor may identify a first global minimum angle that is the smallest of the first minimum angles. The processor may identify the first global minimum angle point, which is used to form the first global minimum angle, from among the first minimum angle points.

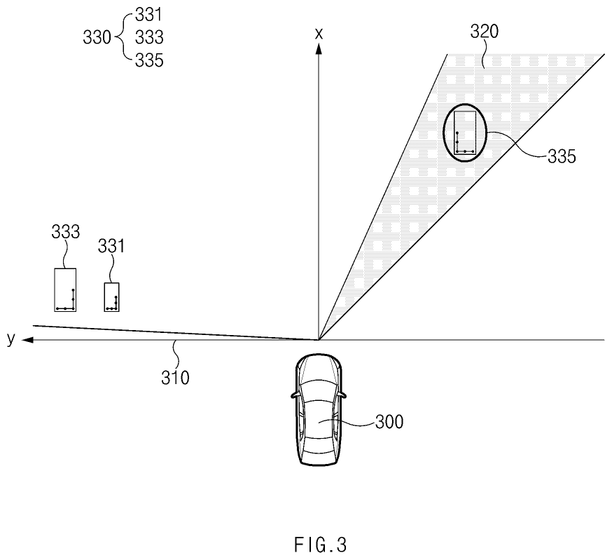

In an example, the processor may determine whether at least one of first minimum angles, first minimum angle points, or any combination thereof is stored in the memory as many as the specified number (e.g., about 50) or more, based on identifying the first global minimum angle point. The processor may identify the maximum angle in a second ROI, which is different from the first ROI 220, based on identifying the first minimum angles and first minimum angle points stored as many as the specified number or more, first minimum angle points stored as many as the specified number or more, or any combination thereof. An operation of identifying the maximum angle in the second ROI is described below with reference to FIG. 3.

In an example, the processor may perform a process of additionally or alternatively obtaining at least one of first minimum angles, first minimum angle points, or any combination thereof from the first ROI 220 based on identifying first minimum angles and first minimum angle points, which are stored such that the number of first minimum angles and first minimum angle points is smaller than the specified number.

FIG. 3 shows an example of a vehicle control apparatus that identifies a maximum angle to generate a first FOV, in an example of the present disclosure.

A host vehicle 300 of FIG. 3 may include the vehicle control apparatus 100 of FIG. 1.

Referring to FIG. 3, a processor of a vehicle control apparatus according to an example may identify a virtual box 330 corresponding to an external object different from the host vehicle 300.

In an example, the processor may identify a half-line 310 facing a positive direction of the y-axis from the host vehicle 300. The processor may identify a second ROI 320 that includes a region rotated clockwise by a second angle greater than a first angle from the half-line 310.

In an example, the processor may use specification information of a LiDAR when specifying the second ROI 320. For example, the processor may specify the second ROI 320 by using angle information included in the specification information of the LiDAR.

For example, the second ROI 320 may include a region between a half-line rotated clockwise by approximately 110 degrees from the half-line 310 and a half-line clockwise rotated by approximately 140 degrees from the half-line 310.

The processor may identify a virtual box 335 in the second ROI 320. The processor may identify a plurality of points included in the virtual box 335 identified in the second ROI 320.

In an example, the processor may obtain second line segments from connecting the host vehicle 300 and each of the plurality of points included in the virtual box 335. The processor may identify angles between the second line segments and the half-line 310. The processor may identify the maximum angle among the angles between the second line segments and the half-line 310.

In an example, in each of a plurality of frames, the processor may obtain the second line segments from connecting the host vehicle 300 and each of the plurality of points included in the virtual box 335. The processor may identify angles between the second line segments and the half-line 310 in each of the plurality of frames. In each of the plurality of frames, the processor may identify the first maximum angles based on identifying the maximum angle among the angles between the second line segments and the half-line 310.

In an example, the processor may store the identified first maximum angles in a memory. The processor may sequentially store the first maximum angles in the memory.

In an example, the processor may store at least one of first maximum angles, first maximum angle points, or any combination thereof in the memory, and the processor may also store at least one of a direction that the LiDAR faces, an index, or any combination thereof.

In an example, the processor may identify a first global maximum angle that is the greatest of the first maximum angles. The processor may identify the first global maximum angle point, which is used to form the first global maximum angle, from among the first maximum angle points.

In an example, the processor may determine whether at least one of first maximum angles, first maximum angle points, or any combination thereof is stored in the memory as many as the specified number (e.g., about 50) or more, based on identifying the first global maximum angle point. In an example, the processor may generate the first FOV by using at least one of the first global minimum angle, the first global minimum angle point, the first global maximum angle, the first global maximum angle point, or any combination thereof based on identifying the first maximum angles stored as many as the specified number or more, and the first maximum angle points stored as many as the specified number or more.

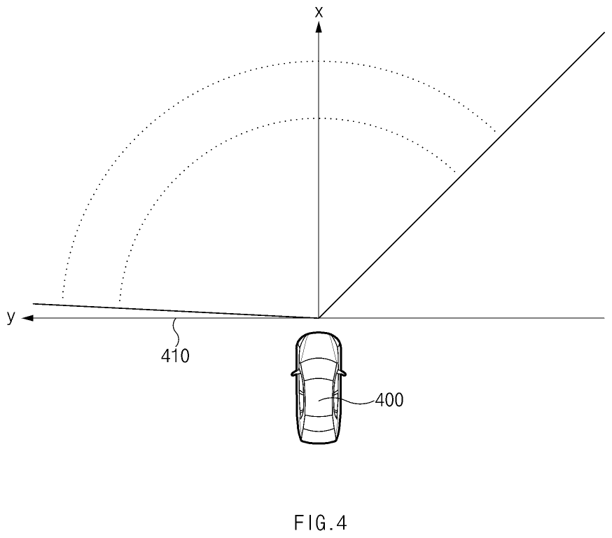

FIG. 4 shows an example of a vehicle control apparatus that identifies a minimum angle and a maximum angle to generate a second FOV, in an example of the present disclosure.

A host vehicle 400 of FIG. 4 may include the vehicle control apparatus 100 of FIG. 1.

Referring to FIG. 4, a processor of the vehicle control apparatus according to an example may identify ground points illustrating a ground. Points shown in FIG. 4 may be referred to as “ground points”.

In an example, the processor may identify ground points in layers of a specified level or lower. For example, the specified level may include approximately 5 levels. The processor may identify ground points in layers of level 5 or lower. For example, the processor may identify ground points in layers between the lowest layer of level 1 and a layer of level 5.

In an example, the processor may identify a half-line 410 facing a positive direction of the y-axis from a host vehicle 400. The processor may identify angles between a half-line 410 and ground points.

In an example, the processor may identify the angles between the half-line 410 and ground points, in a plurality of frames. In the plurality of frames, the processor may identify at least one of a minimum angle, a maximum angle, or any combination thereof among angles between the half-line 410 and ground points.

In an example, in each of the plurality of frames, the processor may obtain the second minimum angles based on identifying the minimum angle between the half-line 410 and ground points. The processor may identify the second minimum angle points for forming the second minimum angles among the ground points.

In an example, in each of the plurality of frames, the processor may obtain the second maximum angles based on identifying the maximum angle between the half-line 410 and ground points. The processor may identify the second maximum angle points for forming the second maximum angles among the ground points.

In an example, the processor may identify at least one of second minimum angles, second minimum angle points, second maximum angles, second maximum angle points, or any combination thereof. The processor may store at least one of second minimum angles, second minimum angle points, second maximum angles, second maximum angle points, or any combination thereof in a memory.

In an example, the processor may store at least one of the second minimum angles, the second minimum angle points, the second maximum angles, second maximum angle points, or any combination thereof in the memory, and the processor may also store at least one of a direction that the LiDAR faces, an index, or any combination thereof.

In an example, the processor may determine whether at least one of the second minimum angles, the second minimum angle points, the second maximum angles, the second maximum angle points, or any combination thereof is stored in the memory as many as the specified number (e.g., about 50).

On the basis of the fact that at least one of the second minimum angles, the second minimum angle points, the second maximum angles, the second maximum angle points, or any combination thereof is stored in a memory as many as the specified number or more, the processor 110 may identify at least one of a second global minimum angle, a second global minimum angle point, a second global maximum angle, a second global maximum angle point, or any combination thereof.

For example, the processor may identify a second global minimum angle that is the smallest of the second minimum angles. The processor may identify the second global minimum angle point, which is used to form the second global minimum angle, from among the second minimum angle points.

For example, the processor may identify a second global maximum angle that is the greatest of the second maximum angles. The processor may identify the second global maximum angle point, which is used to form the second global maximum angle, from among the second maximum angle points.

The processor may generate the second FOV based on at least one of the second global minimum angle, the second global minimum angle point, the second global maximum angle, the second global maximum angle point, or any combination thereof.

For example, the processor may generate the second FOV including the second global minimum angle point and the second global maximum angle point.

On the basis of the fact that at least one of the second minimum angles, the second minimum angle points, the second maximum angles, the second maximum angle points, or any combination thereof is stored in a memory such that the number of second minimum angles, second minimum angle points, second maximum angles, second maximum angle points, or any combination thereof is smaller than the specified number, the processor 110 may additionally or alternatively perform a process of obtaining at least one of second minimum angles, second minimum angle points, second maximum angles, second maximum angle points, or any combination thereof.

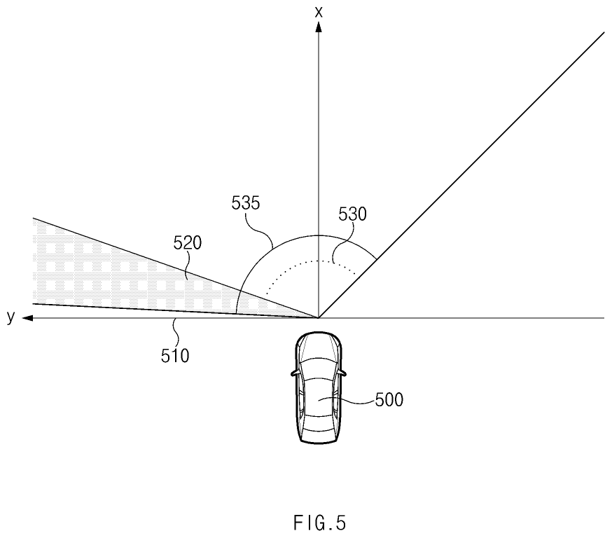

FIG. 5 shows an example in which a vehicle control apparatus determines an abnormal state of a boundary region, according to an example of the present disclosure.

A host vehicle 500 of FIG. 5 may include the vehicle control apparatus 100 of FIG. 1.

Referring to FIG. 5, a processor of the vehicle control apparatus according to an example may identify an abnormal state of a boundary region based on a third FOV and angle information. For example, the processor may specify at least one of a first ROI, a second ROI, or any combination thereof based on a first angle, a second angle, or any combination thereof from a half-line 510 facing a positive direction of a y-axis from the host vehicle 500.

In an example, the processor may identify an angle 535 included in the angle information included in the specification information. The processor may identify a difference between a third FOV 530 and the angle 535 included in the angle information. The processor may determine a state of a boundary region 520 of a LiDAR based on the difference between the third FOV 530 and the angle 535 included in the angle information.

The processor may determine that the state of the boundary region 520 of the LiDAR is an abnormal state, based on the difference between the third FOV 530 and the angle 535 included in the angle information being identified to be greater than or equal to a specified angle.

In an example, before a contamination level of a LiDAR is included in specification information and identified as a threshold value for determining a contamination state of the LiDAR, the processor may determine an abnormal state of the boundary region 520 based on a difference between the third FOV 530 and the angle 535 included in angle information.

As described above, in an example, before the contamination level of the LiDAR is included in specification information and identified as the threshold value for determining a contamination state of the LiDAR, the processor may determine an abnormal state of the boundary region 520 based on a difference between the third FOV 530 and the angle 535 included in angle information and then may provide a guide to a user. The processor may determine the abnormal state of the boundary region 520 and may guide the user such that he/she may take action, thereby preventing performance degradation of the LiDAR.

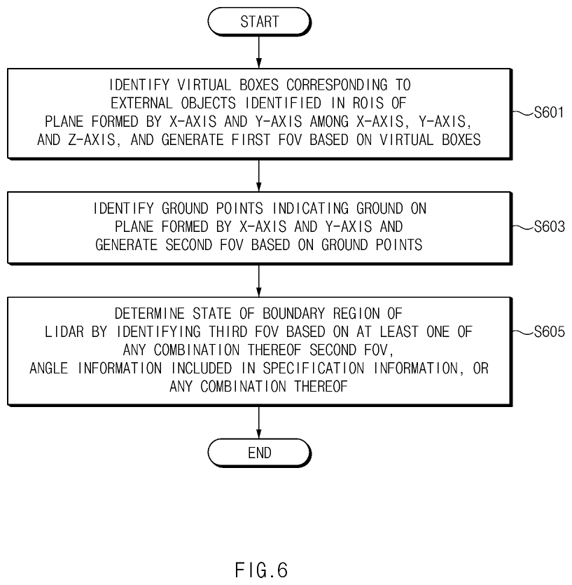

FIG. 6 shows an example of a flowchart related to a vehicle control method, according to an example of the present disclosure.

Hereinafter, it is assumed that the vehicle controlling apparatus 100 of FIG. 1 performs the process of FIG. 6. In addition or alternative, in a description of FIG. 6, it may be understood that an operation described as being performed by an apparatus is controlled by the processor 110 of the vehicle control apparatus 100.

At least one of operations of FIG. 6 may be performed by the vehicle control apparatus 100 of FIG. 1. Each of the operations in FIG. 6 may be performed sequentially, but is not necessarily sequentially performed. For example, the order of operations may be changed, and at least two operations may be performed in parallel.

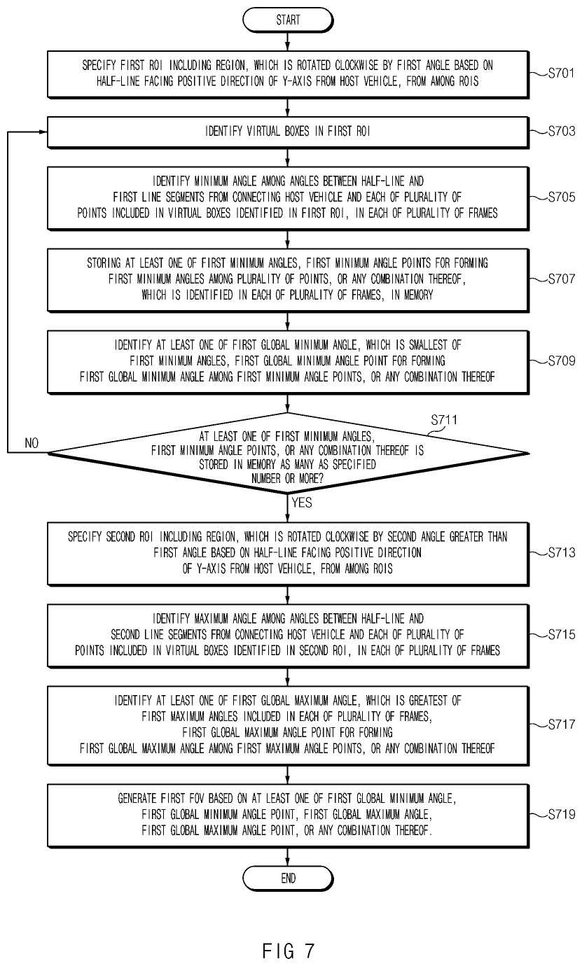

Referring to FIG. 6, in operation S601, a vehicle control method according to an example may include an operation of identifying virtual boxes corresponding to external objects identified in ROIs of a plane formed by an x-axis and a y-axis among the x-axis, the y-axis, and a z-axis, and generating a first FOV based on the virtual boxes. The operation of generating the first FOV is described below in FIG. 7.

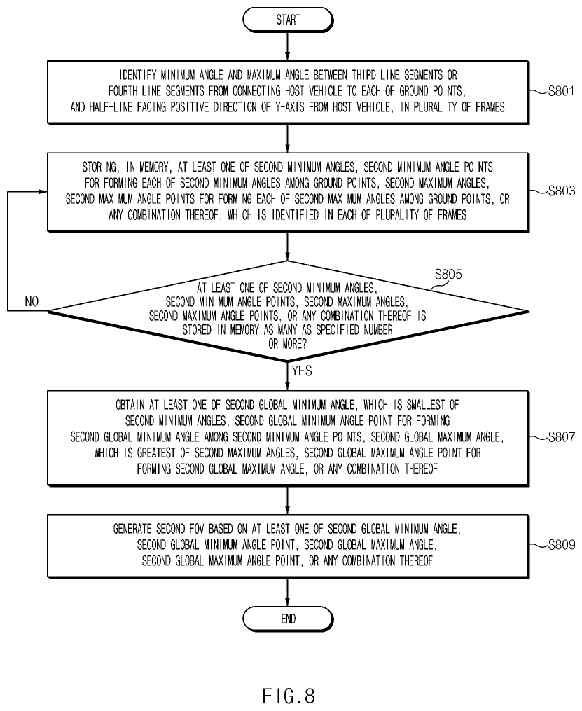

In operation S603, the vehicle control method according to an example may include an operation of identifying ground points indicating the ground on the plane formed by the x-axis and the y-axis and generating a second FOV based on the ground points. The operation of generating the second FOV is described below in FIG. 8.

In operation S605, the vehicle control method according to an example may include an operation of determining a state of a boundary region of a LiDAR, by identifying a third FOV based on at least one of a first FOV, a second FOV, angle information included in specification information, or any combination thereof. For example, the specification information may include information stored in a memory or transmitted from the outside.

The vehicle control method according to an example may include an operation of determining the state of the boundary region of the LiDAR based on a difference between the third FOV and the angle information.

For example, the vehicle control method may include an operation of determining the normal state of the boundary region of the LiDAR based on the difference between the third FOV and angle information being smaller than a specified angle.

For example, the vehicle control method may include an operation of determining the abnormal state of the boundary region of the LiDAR based on the difference between the third FOV and the angle information being greater than or equal to the specified angle. In an example, the vehicle control method may include an operation of determining the abnormal state of at least one of the first ROI, the second ROI, or any combination thereof based on at least one of the first FOV, the second FOV, the third FOV, the angle information, or any combination thereof after determining the abnormal state of the boundary region.

For example, the vehicle control method may include an operation of determining the abnormal state of the first ROI based on the fact that a global minimum angle included in the third FOV is greater than a minimum angle included in the angle information. For example, the vehicle control method may include an operation of determining the abnormal state of the second ROI based on the fact that the global maximum angle included in the third FOV is smaller than the maximum angle included in the angle information.

FIG. 7 shows an example of a flowchart related to a vehicle control method, according to an example of the present disclosure.

Hereinafter, it is assumed that the vehicle controlling apparatus 100 of FIG. 1 performs the process of FIG. 7. In addition or alternative, in a description of FIG. 7, it may be understood that an operation described as being performed by an apparatus is controlled by the processor 110 of the vehicle control apparatus 100.

At least one of operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, in operation S701, a vehicle control method according to an example may include an operation of specifying a first ROI including a region, which is rotated clockwise by a first angle based on a half-line facing a positive direction of a y-axis from a host vehicle, from among ROIs. For example, the first ROI may be referred to as a “low limit area”.

In operation S703, the vehicle control method according to an example may include an operation of identifying virtual boxes in a first ROI. For example, the virtual boxes may include a virtual box corresponding to an external object.

In operation S705, the vehicle control method according to an example may include an operation of identifying a minimum angle among angles between a half-line and first line segments from connecting a host vehicle and each of the plurality of points included in the virtual boxes identified in the first ROI, in each of the plurality of frames.

In operation S707, the vehicle control method according to an example may include an operation of storing at least one of first minimum angles, first minimum angle points for forming the first minimum angles among the plurality of points, or any combination thereof, which is identified in each of the plurality of frames, in a memory.

For example, the vehicle control method may include an operation of sequentially storing at least one of the first minimum angles, the first minimum angle points, or any combination thereof in a specified area of the memory.

For example, the vehicle control method may include an operation of storing at least one of the first minimum angles, the first minimum angle points, or any combination thereof in the specified area of the memory. For example, the specified area of the memory may be referred to as a “queue”.

In operation S709, the vehicle control method according to an example may include an operation of identifying at least one of a first global minimum angle, which is the smallest of the first minimum angles, a first global minimum angle point for forming the first global minimum angle among the first minimum angle points, or any combination thereof.

In operation S711, the vehicle control method according to an example may include an operation of determining whether at least one of the first minimum angles, the first minimum angle points, or any combination thereof is stored in the memory as many as the specified number or more.

If at least one of the first minimum angles, the first minimum angle points, or any combination thereof is stored in the memory as many as the specified number or more (Yes in operation S711), in operation S713, the vehicle control method according to an example may include an operation of specifying a second ROI including a region, which is rotated clockwise by a second angle greater than the first angle based on a half-line facing a positive direction of the y-axis from the host vehicle, from among the ROIs.

If at least one of the first minimum angles, the first minimum angle points, or any combination thereof is stored in the memory such that the number of first minimum angles, first minimum angle points, or any combination thereof is smaller than the specified number (No in operation S711), in operation S703, the vehicle control method according to an example may include an operation of identifying virtual boxes in the first ROI.

For example, the vehicle control method may include an operation of additionally or alternatively identifying the virtual boxes and obtaining at least one of the first minimum angles, the first minimum angle points, or any combination thereof until at least one of the first minimum angles, the first minimum angle points, or any combination thereof is stored in the memory as many as the specified number.

In operation S715, the vehicle control method according to an example may include an operation of identifying a maximum angle among angles between a half-line and second line segments from connecting a host vehicle and each of the plurality of points included in the virtual boxes identified in the second ROI, in each of the plurality of frames.

In operation S717, the vehicle control method according to an example may include an operation of identifying at least one of a first global maximum angle, which is the greatest of the first maximum angles included in each of the plurality of frames, a first global maximum angle point for forming the first global maximum angle among the first maximum angle points, or any combination thereof.

In operation S719, the vehicle control method according to an example may include an operation of generating the first FOV based on at least one of the first global minimum angle, the first global minimum angle point, the first global maximum angle, the first global maximum angle point, or any combination thereof.

For example, the vehicle control method may include an operation of generating the first FOV based on a region between the first global minimum angle point and the first global maximum angle point.

FIG. 8 shows an example of a flowchart related to a vehicle control method, according to an example of the present disclosure.

Hereinafter, it is assumed that the vehicle controlling apparatus 100 of FIG. 1 performs the process of FIG. 8. In addition or alternative, in a description of FIG. 8, it may be understood that an operation described as being performed by an apparatus is controlled by the processor 110 of the vehicle control apparatus 100.

At least one of operations of FIG. 8 may be performed by the vehicle control apparatus 100 of FIG. 1. Each of the operations in FIG. 8 may be performed sequentially, but is not necessarily sequentially performed. For example, the order of operations may be changed, and at least two operations may be performed in parallel.

Referring to FIG. 8, in operation S801, a vehicle control method according to an example may include an operation of identifying a minimum angle and a maximum angle between third line segments or fourth line segments from connecting a host vehicle to each of ground points, and a half-line facing a positive direction of a y-axis from the host vehicle, in a plurality of frames.

For example, the vehicle control method may include an operation of identifying the third line segments from connecting the host vehicle to each of the ground points. For example, the vehicle control method may include an operation of identifying the fourth line segments from connecting the host vehicle to each of the ground points.

For example, the vehicle control method may include an operation of identifying an angle between the third line segments and the half-line facing the positive direction of the y-axis from the host vehicle. For example, the vehicle control method may include an operation of identifying an angle between the fourth line segments and the half-line facing the positive direction of the y-axis from the host vehicle.

For example, the vehicle control method may include an operation of identifying a minimum angle among angles between the third line segments and the half-line facing the positive direction of the y-axis from the host vehicle. For example, the vehicle control method may include an operation of identifying a maximum angle among angles between the fourth line segments and the half-line facing the positive direction of the y-axis from the host vehicle.

In operation S803, the vehicle control method according to an example may include an operation of storing, in a memory, at least one of second minimum angles, second minimum angle points for forming each of the second minimum angles among the ground points, second maximum angles, second maximum angle points for forming each of the second maximum angles among the ground points, or any combination thereof, which is identified in each of a plurality of frames.

For example, the vehicle control method may include an operation of sequentially storing at least one of second minimum angles, second minimum angle points, second maximum angles, second maximum angle points, or any combination thereof in the memory.

In operation S805, the vehicle control method according to an example may include an operation of determining whether at least one of the second minimum angles, the second minimum angle points, the second maximum angles, the second maximum angle points, or any combination thereof is stored in the memory as many as the specified number or more.

For example, the vehicle control method may include an operation of determining whether at least one of the second minimum angles, the second minimum angle points, the second maximum angles, the second maximum angle points, or any combination thereof is stored in a specified area of the memory as many as the specified number or more.

If at least one of the second minimum angles, the second minimum angle points, the second maximum angles, the second maximum angle points, or any combination thereof is stored in the memory as many as the specified number or more (Yes in operation S805), in operation S807, the vehicle control method according to an example may include an operation of obtaining at least one of a second global minimum angle, which is the smallest of the second minimum angles, a second global minimum angle point for forming the second global minimum angle among the second minimum angle points, a second global maximum angle, which is the greatest of the second maximum angles, a second global maximum angle point for forming the second global maximum angle, or any combination thereof.

If at least one of the second minimum angles, the second minimum angle points, the second maximum angles, the second maximum angle points, or any combination thereof is stored in the memory as many as the specified number or more (No in operation S805), in operation S803, the vehicle control method according to an example may include an operation of additionally or alternatively performing an operation of storing, in a memory, at least one of second minimum angles, second minimum angle points for forming each of the second minimum angles among the ground points, second maximum angles, second maximum angle points for forming each of the second maximum angles among the ground points, or any combination thereof, which is identified in each of a plurality of frames.

In operation S809, the vehicle control method according to an example may include an operation of generating the second FOV based on at least one of the second global minimum angle, the second global minimum angle point, the second global maximum angle, the second global maximum angle point, or any combination thereof.

For example, the vehicle control method may include an operation of generating a second FOV including a region between the second global minimum angle and the second global maximum angle.

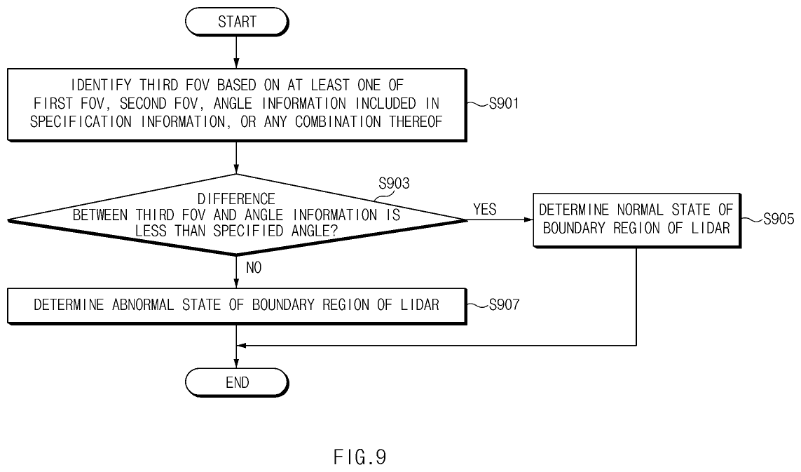

FIG. 9 shows an example of a flowchart related to a vehicle control method, according to an example of the present disclosure.

Hereinafter, it is assumed that the vehicle controlling apparatus 100 of FIG. 1 performs the process of FIG. 9. In addition or alternative, in a description of FIG. 9, it may be understood that an operation described as being performed by an apparatus is controlled by the processor 110 of the vehicle control apparatus 100.

At least one of operations of FIG. 9 may be performed by the vehicle control apparatus 100 of FIG. 1. Each of the operations in FIG. 9 may be performed sequentially, but is not necessarily sequentially performed. For example, the order of operations may be changed, and at least two operations may be performed in parallel.

Referring to FIG. 9, in operation S901, a vehicle control method according to an example may include an operation of identifying a third FOV based on at least one of a first FOV, a second FOV, angle information included in specification information, or any combination thereof.

For example, the vehicle control method may include an operation of identifying a FOV that is the closer to the angle information among the first FOV and second FOV. For example, the vehicle control method may include an operation of identifying the third FOV based on identifying a FOV that is the closer to the angle information among the first FOV and second FOV.

In operation S903, the vehicle control method according to an example may include an operation of determining whether a difference between the third FOV and the angle information is less than a specified angle. The vehicle control method may include an operation of determining a state of a boundary region of a LiDAR based on the difference between the third FOV and the angle information.

If the difference between the third FOV and the angle information is smaller than the specified angle (Yes in operation S903), in operation S905, the vehicle control method according to an example may include an operation of determining a normal state of the boundary region of the LiDAR.

If the difference between the third FOV and the angle information is greater than or equal to the specified angle (No in operation S903), in operation S907, the vehicle control method according to an example may include an operation of determining an abnormal state of the boundary region of the LiDAR.

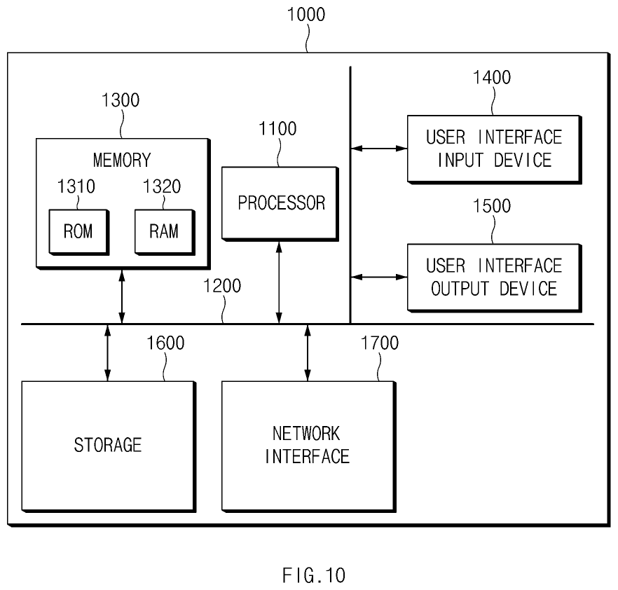

FIG. 10 shows a computing system including a vehicle control apparatus, according to an example of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure has been made to solve the above-mentioned problems occurring in the prior art while advantages achieved by the prior art are maintained intact.

An example of the present disclosure provides a vehicle control apparatus that identifies FOV of a LiDAR by using virtual boxes corresponding to external objects obtained by using the LiDAR, or ground points indicating the ground, and a method thereof.

An example of the present disclosure provides a vehicle control apparatus that determines the state of a boundary region of the LiDAR by identifying the FOV of the LiDAR and comparing the identified FOV with specification information of the LiDAR, and a method thereof.

An example of the present disclosure provides a vehicle control apparatus that determines the state of the boundary region of the LiDAR by using the FOV before a contamination level of LiDAR is identified as a threshold value, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a light detection and ranging (LiDAR), a processor, and a memory. The processor may identify virtual boxes corresponding to external objects identified in regions of interest (ROIs) of a plane formed by a first axis and a second axis among the first axis, the second axis, and a third axis, in a plurality of frames obtained by using the LiDAR and generate a first field of view (FOV) based on the virtual boxes, may identify ground points indicating a ground on the plane and generate a second FOV based on the ground points, and to determine a state of a boundary region of the LiDAR by identifying a third FOV based on at least one of the first FOV, the second FOV, angle information included in the specification information, or a combination of the first FOV, the second FOV, and the angle information.

In an example, the processor may specify a first region of interest (ROI) including a region, which is rotated clockwise by a first angle based on a half-line facing a positive direction of the second axis from a host vehicle, from among the ROIs, and may identify the virtual boxes in the first ROI.

In an example, the processor may identify a minimum angle among angles between the half-line and first line segments from connecting the host vehicle and each of a plurality of points included in the virtual boxes identified in the first ROI, in each of the plurality of frames, and may store, in the memory, at least one of first minimum angles, first minimum angle points for forming each of the first minimum angles among the plurality of points, or a combination of the first minimum angles and the first minimum angle points, which are identified in each of the plurality of frames.

In an example, the processor may obtain at least one of a first global minimum angle, which is the smallest of the first minimum angles, a first global minimum angle point for forming the first global minimum angle among the first minimum angle points, or a combination of the first global minimum angle and the first global minimum angle point, and may determine reliability of at least one of the first global minimum angle, the first global minimum angle point, or the combination of the first global minimum angle and the first global minimum angle point based on determining whether at least one of the first minimum angles, the first minimum angle points, or a combination of the first minimum angles and the first minimum angle points is stored in the memory as many as a specified number or more.

In an example, the processor may specify a second ROI including a region, which is rotated clockwise by a second angle greater than the first angle based on the half-line facing the positive direction of the second axis from the host vehicle, from among the ROIs, and may identify the virtual boxes in the second ROI.

In an example, the processor may identify a maximum angle among angles between the half-line and second line segments from connecting the host vehicle and each of a plurality of points included in the virtual boxes identified in the second ROI, in each of the plurality of frames, and may store, in the memory, at least one of first maximum angles, first maximum angle points for forming each of the first maximum angles among the plurality of points, or a combination of the first maximum angles and the first maximum angle points, which are identified in each of the plurality of frames.

In an example, the processor may obtain at least one of a first global maximum angle, which is the smallest of the first maximum angles, a first global maximum angle point for forming the first global maximum angle among the first maximum angle points, or a combination of the first global maximum angle and the first global maximum angle point, and may determine reliability of at least one of the first global maximum angle, the first global maximum angle point, or the combination of the first global maximum angle and the first global maximum angle point based on determining whether at least one of the first maximum angles, the first maximum angle points, or a combination of the first maximum angles and the first maximum angle points is stored in the memory as many as a specified number or more.

In an example, the processor may identify a minimum angle among angles between a half-line facing a positive direction of the second axis from a host vehicle, and third line segments from connecting the host vehicle and each of the ground points, in each of the plurality of frames, and may store, in the memory, at least one of second minimum angles, second minimum angle points for forming each of the second minimum angles among the ground points, or a combination of the second minimum angles and the second minimum angle points, which are identified in each of the plurality of frames.

In an example, the processor may obtain at least one of a second global minimum angle, which is the smallest of the second minimum angles, a second global minimum angle point for forming the second global minimum angle among the second minimum angle points, or a combination of the second global minimum angle and the second global minimum angle point, and may determine reliability of at least one of the second global minimum angle, the second global minimum angle point, or the combination of the second global minimum angle and the second global minimum angle point based on determining whether at least one of the second minimum angles, the second minimum angle points, or a combination of the second minimum angles and the second minimum angle points is stored in the memory as many as a specified number or more.

In an example, the processor may identify a maximum angle among angles between a half-line facing a positive direction of the second axis from a host vehicle, and fourth line segments from connecting the host vehicle and each of the ground points, in each of the plurality of frames, and may store, in the memory, at least one of second maximum angles, second maximum angle points for forming each of the second maximum angles among the ground points, or a combination of the second maximum angles and the second maximum angle points, which are identified in each of the plurality of frames.

In an example, the processor may obtain at least one of a second global maximum angle, which is the smallest of the second maximum angles, a second global maximum angle point for forming the second global maximum angle among the second maximum angle points, or a combination of the second global maximum angle and the second global maximum angle point, and may determine reliability of at least one of the second global maximum angle, the second global maximum angle point, or the combination of the second global maximum angle and the second global maximum angle point based on determining whether at least one of the second maximum angles, the second maximum angle points, or a combination of the second maximum angles and the second maximum angle points is stored in the memory as many as a specified number or more.

In an example, the processor may determine a normal state of the boundary region of the LiDAR based on a difference between the third FOV and the angle information included in the specification information being smaller than a specified angle.

In an example, the processor may determine an abnormal state of the boundary region of the LiDAR based on a difference between the third FOV and the angle information included in the specification information being greater than or equal to a specified angle.

In an example, the processor may determine an abnormal state of at least one of the first ROI, the second ROI, or a combination of the first ROI and the second ROI based on at least one of the first FOV, the second FOV, the third FOV, the angle information, or a combination of the first FOV, the second FOV, the third FOV, and the angle information after determining the abnormal state.

In an example, the processor may determine a state of the boundary region based on at least one of the first FOV, the second FOV, the third FOV, the angle information included in the specification information, or a combination of the first FOV, the second FOV, the third FOV, and the angle information before a contamination level of the LiDAR is included in the specification information and is identified as a threshold value for determining a contamination state of the LiDAR.

According to an example of the present disclosure, a vehicle control method may include identifying virtual boxes corresponding to external objects identified in ROIs of a plane formed by a first axis and a second axis among the first axis, the second axis, and a third axis, in a plurality of frames obtained by using a LiDAR and generating a first FOV based on the virtual boxes, identifying ground points indicating a ground on the plane and generating a second FOV based on the ground points, and determining a state of a boundary region of the LiDAR by identifying a third FOV based on at least one of the first FOV, the second FOV, angle information included in specification information of the LiDAR, or a combination of the first FOV, the second FOV, and the angle information.

According to an example, the vehicle control method may further include specifying a first ROI including a region, which is rotated clockwise by a first angle based on a half-line facing a positive direction of the second axis from a host vehicle, from among the ROIs, specifying a second ROI including a region, which is rotated clockwise by a second angle greater than the first angle based on the half-line, identifying a minimum angle among angles between the half-line and first line segments from connecting the host vehicle and each of a plurality of points included in the virtual boxes identified in the first ROI, in each of the plurality of frames, and identifying a maximum angle among angles between the half-line and second line segments from connecting the host vehicle and each of a plurality of points included in the virtual boxes identified in the second ROI, in each of the plurality of frames, identifying at least one of first minimum angles identified in each of the plurality of frames, first minimum angle points for forming each of the first minimum angles among the plurality of points, first maximum angles identified in each of the plurality of frames, first maximum angle points for forming each of the first maximum angles among the plurality of points, or a combination of the first minimum angles, the first minimum angle points, the first maximum angles, and the first maximum angle points, and generating the first FOV based on at least one of a first global minimum angle, which is the smallest of the first minimum angles, a first global minimum angle point for forming the first global minimum angle among the first minimum angle points, a first global maximum angle, which is the greatest of the first maximum angles, a first global maximum angle point for forming the first global maximum angle among the first maximum angle points, or a combination of the first global minimum angle, the first global minimum angle point, the first global maximum angle, and the first global maximum angle point.

According to an example, the vehicle control method may further include identifying a minimum angle among angles between a half-line facing a positive direction of the second axis from a host vehicle, and third line segments from connecting the host vehicle and each of the ground points, in each of the plurality of frames, and identifying a maximum angle among angles between a half-line facing a positive direction of the second axis from the host vehicle, and fourth line segments from connecting the host vehicle and each of the ground points, in each of the plurality of frames, and generating the second FOV based on at least one of a second global minimum angle, which is the smallest of the second minimum angles, a second global minimum angle point for forming the second global minimum angle among the second minimum angle points, a second global maximum angle, which is the greatest of the second maximum angles, a second global maximum angle point for forming the second global maximum angle among the second maximum angle points, or a combination of the second global minimum angle, the second global minimum angle point, the second global maximum angle, and the second global maximum angle point.

According to an example, the vehicle control method may further include determining a normal state of the boundary region of the LiDAR based on a difference between the third FOV and the angle information included in the specification information being smaller than a specified angle, or determining an abnormal state of the boundary region of the LiDAR based on the difference between the third FOV and the angle information included in the specification information being greater than or equal to the specified angle.

According to an example, the vehicle control method may further include identifying a maximum angle among angles between the half-line and second line segments from connecting the host vehicle and each of a plurality of points included in the virtual boxes identified in the second ROI, in each of the plurality of frames, and storing, in the memory, at least one of first maximum angles, first maximum angle points for forming each of the first maximum angles among the plurality of points, or a combination of the first maximum angles and the first maximum angle points, which are identified in each of the plurality of frames.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

According to an example of the present disclosure, a vehicle control apparatus may identify FOV of a LiDAR by using virtual boxes corresponding to external objects obtained by using the LiDAR, or ground points indicating the ground.

Moreover, according to an example of the present disclosure, a vehicle control apparatus may determine the state of a boundary region of the LiDAR by identifying the FOV of the LiDAR and comparing the identified FOV with specification information of the LiDAR.

According to an example of the present disclosure, a vehicle control apparatus may determine the state of the boundary region of the LiDAR by using the FOV before a contamination level of LiDAR is identified as a threshold value.

Besides, a variety of effects directly or indirectly understood through the specification may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a sensor;
a processor; and
a memory configured to store specification information of the sensor,
wherein the processor is configured to:
determine, based on a plurality of frames obtained by using the sensor, a plane formed by a first axis and a second axis, the second axis corresponding to a driving direction of the vehicle, and the first axis being perpendicular to the second axis;
detect objects, external to the vehicle, in regions of interest of the plane;
determine virtual boxes corresponding to the objects;
generate a first field of view (FOV) based on the virtual boxes;
determine ground points indicating a ground on the plane;
generate a second FOV based on the ground points;
generate a third FOV based on at least one of:
the first FOV,
the second FOV, or
angle information included in the specification information;
determine a state of a boundary region of the sensor based on the third FOV; and
output a signal indicating the determined state of the boundary region of the sensor.

2. The apparatus of claim 1, wherein the processor is configured to:
specify a first region of interest (ROI) of the regions of interest, wherein the first ROI includes a region, which is between:
a line rotated by a first angle from a half-line facing a positive direction of the second axis, and
the half-line; and
determine virtual boxes in the first ROI.

3. The apparatus of claim 2, wherein the processor is configured to:
determine a plurality of line segments, each of the plurality of line segments connecting the vehicle and one of a plurality of points included in the virtual boxes in the first ROI;
determine a plurality of angles between:
the plurality of line segments, and
the half-line;
determine a minimum angle among the plurality of angles, in each of the plurality of frames; and
store, in the memory, at least one of:
first minimum angles comprising the minimum angle, or
first minimum angle points, of the plurality of points, for forming each of the first minimum angles, wherein the first minimum angle points are determined in each of the plurality of frames.

4. The apparatus of claim 3, wherein the processor is configured to:
obtain at least one of:
a first global minimum angle, which is the smallest of the first minimum angles, or
a first global minimum angle point, of the first minimum angle points, for forming the first global minimum angle; and
determine a reliability value of at least one of:
the first global minimum angle, or
the first global minimum angle point,
based on determining whether at least one of:
a number of the first minimum angles stored in the memory, or
a number of the first minimum angle points stored in the memory
satisfies a threshold number.

5. The apparatus of claim 2, wherein the processor is configured to:
specify a second ROI including a region, which is between:
a line rotated by a second angle, greater than the first angle, from the half-line, and
another line rotated by a third angle from the half-line; and
determine virtual boxes in the second ROI.

6. The apparatus of claim 5, wherein the processor is configured to:
determine a plurality of line segments, each of plurality of line segments connecting the vehicle and one of a plurality of points included in the virtual boxes in the second ROI;
determine a plurality of angles between:
the plurality of line segments, and
the half-line;
determine a maximum angle among the plurality of angles, in each of the plurality of frames; and
store, in the memory, at least one of:
first maximum angles comprising the maximum angle, or
first maximum angle points, of the plurality of points, for forming each of the first maximum angles, wherein the first maximum angle points are determined in each of the plurality of frames.

7. The apparatus of claim 6, wherein the processor is configured to:
obtain at least one of:
a first global maximum angle, which is the smallest of the first maximum angles, or
a first global maximum angle point, of the first maximum angle points, for forming the first global maximum angle; and
determine a reliability value of at least one of:
the first global maximum angle, or
the first global maximum angle point,
based on determining whether at least one of:
a number of the first maximum angles stored in the memory, or
a number of the first maximum angle points stored in the memory
satisfies a threshold number.

8. The apparatus of claim 1, wherein the processor is configured to:
determine a plurality of third line segments, each of the plurality of third line segments connecting the vehicle and one of the ground points;
determine a plurality of angles between:
the plurality of third line segments, and
a half-line facing a positive direction of the second axis;
identify a minimum angle among the plurality of angles, in each of the plurality of frames; and
store, in the memory, at least one of:
second minimum angles comprising the minimum angle, or
second minimum angle points, of the ground points, for forming each of the second minimum angles, wherein the second minimum angle points are determined in each of the plurality of frames.

9. The apparatus of claim 8, wherein the processor is configured to:
obtain at least one of:
a second global minimum angle, which is the smallest of the second minimum angles, or
a second global minimum angle point, of the second minimum angle points, for forming the second global minimum angle; and
determine a reliability value of at least one of:
the second global minimum angle, or
the second global minimum angle point,
based on determining whether at least one of:
a number of the second minimum angles stored in the memory, or
a number of the second minimum angle points stored in the memory
satisfies a threshold number.

10. The apparatus of claim 1, wherein the processor is configured to:
determine a plurality of fourth line segments, each of the plurality of fourth line segments connecting the vehicle and one of the ground points;
determine a plurality of angles between:
the plurality of fourth line segments, and
a half-line facing a positive direction of the second axis;
identify a maximum angle among the plurality of angles, in each of the plurality of frames; and
store, in the memory, at least one of:
second maximum angles comprising the maximum angle, or
second maximum angle points, of the ground points, for forming each of the second maximum angles, wherein the second maximum angle points are determined in each of the plurality of frames.

11. The apparatus of claim 10, wherein the processor is configured to:
obtain at least one of:
a second global maximum angle, which is the smallest of the second maximum angles, or
a second global maximum angle point, of the second maximum angle points, for forming the second global maximum angle; and
determine a reliability value of at least one of:
the second global maximum angle, or
the second global maximum angle point,
based on determining whether at least one of:
a number of the second maximum angles stored in the memory, or
a number of the second maximum angle points stored in the memory
satisfies a threshold number.

12. The apparatus of claim 1, wherein the processor is configured to:
determine a normal state of the boundary region of the sensor based on a difference between the third FOV and the angle information satisfying a threshold angle.

13. The apparatus of claim 5, wherein the processor is configured to:
determine an abnormal state of the boundary region of the sensor based on a difference between the third FOV and the angle information satisfying a threshold angle.

14. The apparatus of claim 13, wherein the processor is configured to:
after determining the abnormal state of the boundary region, determine an abnormal state of at least one of:
the first ROI, or
the second ROI,
based on at least one of:
the first FOV,
the second FOV,
the third FOV, or
the angle information.

15. The apparatus of claim 1, wherein the processor is configured to:
before determining a contamination state of the sensor and including a contamination level of the sensor in the specification information, determine a state of the boundary region based on at least one of:
the first FOV,
the second FOV,
the third FOV, or
the angle information, wherein the contamination state is determined based on the contamination level satisfying a threshold value.

16. A method for controlling a vehicle, the method comprising:
obtaining, by a sensor, a plurality of frames;
determining, based on the plurality of frames, a plane formed by a first axis and a second axis, the second axis corresponding to a driving direction of the vehicle, and the first axis being perpendicular to the second axis;
detecting objects, external to the vehicle, in regions of interest of the plane;
determining virtual boxes corresponding to the objects;
generating a first field of view (FOV) based on the virtual boxes;
determining ground points indicating a ground on the plane;
generating a second FOV based on the ground points;
generating a third FOV based on at least one of:
the first FOV,
the second FOV, or
angle information included in specification information of the sensor;
determining a state of a boundary region of the sensor based on the third FOV; and
outputting a signal indicating the determined state of the boundary region of the sensor.

17. The method of claim 16, further comprising:
specifying a first region of interest (ROI) of the regions of interest, wherein the first ROI includes a region which is between:
a line rotated by a first angle from a half-line facing a positive direction of the second axis, and
the half-line;
determining virtual boxes in the first ROI;
specifying a second ROI including a region, which is between:
a line rotated by a second angle, greater than the first angle, from the half-line, and
another line rotated by a third angle from the half-line;
determining virtual boxes in the second ROI;
determining a plurality of first line segments, each of the plurality of first line segments connecting the vehicle and one of a plurality of first points included in the virtual boxes in the first ROI;
determining a plurality of first angles between:
the plurality of first line segments, and
the half-line;
determining a minimum angle among the plurality of first angles, in each of the plurality of frames;
determining a plurality of second line segments, each of the plurality of second line segments connecting the vehicle and one of a plurality of second points included in the virtual boxes in the second ROI;
determining a plurality of second angles between:
the plurality of second line segments, and
the half-line;
determining a maximum angle among the plurality of second angles, in each of the plurality of frames;
determining at least one of:
first minimum angles determined in each of the plurality of frames,
first minimum angle points, of the plurality of first points, for forming each of the first minimum angles,
first maximum angles determined in each of the plurality of frames, or
first maximum angle points, of the plurality of second points, for forming each of the first maximum angles; and
generating the first FOV based on at least one of:
a first global minimum angle, which is the smallest of the first minimum angles,
a first global minimum angle point, of the first minimum angle points, for forming the first global minimum angle,
a first global maximum angle, which is the greatest of the first maximum angles, or
a first global maximum angle point, of the first maximum angle points, for forming the first global maximum angle.

18. The method of claim 16, further comprising:
determining a plurality of third line segments, each of the plurality of third line segments connecting the vehicle and one of the ground points;
determining a plurality of first angles between:
the plurality of third line segments, and
a half-line facing a positive direction of the second axis;
determining a minimum angle among the plurality of first angles, in each of the plurality of frames;
determining a plurality of fourth line segments, each of the plurality of fourth line segments connecting the vehicle and one of the ground points;
determining a plurality of second angles between:
the plurality of third line segments, and
the half-line;
determining a maximum angle among the plurality of second angles, in each of the plurality of frames; and
generating the second FOV based on at least one of:
a second global minimum angle, which is the smallest of second minimum angles,
a second global minimum angle point, of second minimum angle points, for forming the second global minimum angle,
a second global maximum angle, which is the greatest of second maximum angles, or
a second global maximum angle point, of second maximum angle points, for forming the second global maximum angle among the second maximum angle points.

19. The method of claim 16, further comprising:
determining a normal state of the boundary region of the sensor based on a difference between the third FOV and the angle information satisfying a threshold angle; or
determining an abnormal state of the boundary region of the sensor based on the difference between the third FOV and the angle information not satisfying the threshold angle.

20. The method of claim 17, further comprising:
storing, in a memory, at least one of:
the first maximum angles, or
the first maximum angle points for forming each of the first maximum angles, wherein the first maximum angles are determined in each of the plurality of frames.
